(19) United States
(12) Patent Application Publication
(10) Pub. No.: US 2025/0136055 A1
(43) Pub. Date: May 1, 2025

(54) WIPER BLADE

(71) Applicant: VALEO SYSTEMES D'ESSUYAGE, La Verriere (FR)

(72) Inventors: Vincent GAUCHER, La Verriere (FR); Stephane HOUSSAT, La Verrière (FR); Guillaume MOULEYRE, La Verrière (FR); Philippe BILLOT, La Verrière (FR)

(73) Assignee: VALEO SYSTEMES D'ESSUYAGE, La Verriere (FR)

(21) Appl. No.: 18/837,208

(22) PCT Filed: Jan. 24, 2023
(86) PCT No.: PCT/EP2023/051715

§ 371 Date: Aug. 9, 2024

(30) Foreign Application Priority Data
Feb. 22, 2022 (FR) FR2201578

(51) Int. Cl. B60S 1/38

(52) U.S. Cl. CPC B60S 1/381

(57) ABSTRACT

The present invention relates to a wiper blade for a glazed surface. The wiper blades includes a support, a wiping lip borne by the support, a connector secured to the support, and at least one air deflector which includes at least a body and a wing projecting from the body. The wing and the body extending along a longitudinal axis of the wiper blade. The wing includes a rectilinear portion and a curved portion as seen along the longitudinal axis of the wiper blade, the curved portion of the wing being arranged at a longitudinal end of the support.

### TECHNICAL FIELD

The present invention relates to the field of vehicle wiping systems. More particularly, the invention relates to a wiper blade for a system for wiping a glazed surface of a vehicle, notably a motor vehicle.

### BACKGROUND OF THE INVENTION

These days, there is a vehicle window wiping technology known as “flat blade” wipers. A flat blade is a longitudinal structure consisting mainly of two functionally distinct parts.

A first part is a support generally made of a flexible and semi rigid plastics material. The support comprises, on the one hand, a cavity in which a pressure-distribution strip, generally made of metal, and also referred to as a spine, is housed and, on the other hand, a clip bearing an elastomer wiping blade rubber.

A second part of the structure comprises at least one accessory intended to improve the quality of the wiping. This accessory is, for example, an aerodynamic deflector which uses the relative wind of the vehicle to increase the force of contact of the wiper blade rubber with the glazed surface that is to be wiped.

Protective end caps are provided at the longitudinal end of the wiper blade in order to hold the constituent elements of the wiper blade, namely the spine, the wiper blade rubber, the deflector and the support, together.

The protective caps have a tendency to generate or even amplify the phenomena of lifting at the longitudinal ends of the wiper blade. The phenomena of lifting are due to a lifting force which is perpendicular to the direction of the airflow over the wiper blade and which is oriented in a direction away from the glazed surface when the vehicle is in motion. As a consequence, the aerodynamic performance of the wiper blade is diminished, as is the quality of the wiping.

These phenomena are all the more complicated to eliminate as they occur in a region of the wiper blade at which, unless the spine is stiffened, additional forces cannot be applied to the wiper blade in order to counter them. This solution is unsuitable in that it would prevent the wiper blade rubber from remaining in contact with the glazed surface for at least the time taken to wipe the glazed surface.

Furthermore, notably for reasons of economy, the deflector is obtained by extrusion which means that it has to maintain a constant profile. A profile that is constant does not allow the aerodynamic performance to be optimized over the entire length of the wiper blade. Neither does a profile that is constant allow due consideration to be given to the vehicle environment, such as the blade holders for example or the wiper blade connector, which may be disruptive.

### SUMMARY OF THE INVENTION

The object of the present invention is to overcome at least one of the aforementioned disadvantages and also to lead to other advantages by proposing a new type of wiper blade for a vehicle, notably a motor vehicle, wiping system.

A second object of the invention is to propose a wiper blade the components of which are easy to manufacture and to assemble.

A third object of the invention is to provide a wiper blade that is inexpensive to manufacture.

The present invention proposes a wiper blade for a glazed surface, notably of a motor vehicle, comprising a support, a wiping lip borne by the support, a connector secured to the support and at least one air deflector which comprises at least a body and a wing projecting from the body. The wing and the body extend along a longitudinal axis of the wiper blade. The wing comprises a rectilinear portion and a curved portion, as viewed along the longitudinal axis of the wiper blade, the curved portion of the wing being located at a longitudinal end of the support.

The present invention relates notably to a wiper blade the deflector of which is distinctive in that it comprises a wing comprising a rectilinear portion and a curved portion. The curved portion is neither straight nor made up of straight lines. This specific shape of the wing makes it possible to improve the aerodynamic performance of the wiper blade. The curved shape of blade that is arranged at one longitudinal end of the deflector support makes it possible to reduce the lifting force that is notably applied to the ends of the wiper blade, without increasing the drag force.

According to one embodiment, the curved portion of the wing extends over 5% to 55% of a half-length of the deflector, measured along the longitudinal axis. As a preference, the curved portion of the wing extends over 10% to 20% of the half-length of the deflector.

According to one embodiment, the curved portion extends the rectilinear portion as far as a median longitudinal plane of the wiper blade in which plane is inscribed a surface of contact of the wiping lip with the glazed surface, a free end of the curved portion being inscribed in the median longitudinal plane.

According to one embodiment, a free end of the curved portion terminates level with a terminal edge of the body which closes one end of the air deflector. The curved portion is thus positioned at a free and closed end of the deflector, rather than at its open end via which it can be slipped onto the support of the wiper blade.

According to one embodiment, the curved portion is inscribed inside a plurality of circles, the centers of the circles being non-coincident. In other words, the curved portion corresponds to a succession of circular arcs as viewed in a plane containing the longitudinal axis of the wiper blade and an overall axis of airflow over the wiper blade when the vehicle is in motion.

According to one embodiment, the circles of the plurality of circles have identical radii.

According to one embodiment, the circles of the plurality of circles have different radii. According to one embodiment, at least one circle of the plurality of circles has a radius

of between 5 mm and 180 mm.

According to one embodiment, the rectilinear portion of the wing terminates level with a longitudinal edge of the body at which the deflector is open. In other words, the rectilinear portion follows the longitudinal edge of the body, terminating at an intersection of an upper face of the body with an open terminal face of the body.

According to one embodiment, a height of the curved portion diminishes from the rectilinear portion as far as a free end of the curved portion. The height is measured from an upper face of an upper wall of the body as far as a top of the curved portion of the wing along an axis perpendicular to the median longitudinal plane of the wiper blade in which plane the surface of contact of the wiping lip with the glazed surface is inscribed.

According to one embodiment, a terminal part of the deflector at least partially covers a longitudinal end of the support and a terminal part of the wiping lip.

According to one embodiment, the curved portion of the wing is formed integrally with the rectilinear portion of the wing and the body so as to form a one-piece deflector. Here, and throughout the following text, the term “formed integrally” should be understood to mean that the elements that are formed integrally form a single component and are therefore made of the same material or materials. This component can be obtained for example by molding, notably injection molding. This component therefore differs from elements that are joined together by welding or bonding. These integrally formed elements thus cannot be separated without destroying one and/or the other of these elements.

According to one embodiment, the curved portion of the wing is an end piece distinct from the rectilinear portion and arranged at a longitudinal end of the support.

According to one embodiment, the deflector is made of at least one synthetic material.

According to one embodiment, the deflector has a hardness of between 75 and 78 on the Shore scale.

A deflector exhibiting a hardness within this range is not excessively stiff, which means that the blade can maintain its performance.

The invention also relates to a method for assembling the wiper blade exhibiting at least one of the above-mentioned features, during which method of assembly the wiper blade rubber is placed on the support and, in a subsequent step, the air deflector is slipped onto the support from a longitudinal end thereof until the curved portion covers the longitudinal end of the support. In other words, part of the support is inserted into the deflector so that the deflector envelops the inserted part of the support. Thus, the deflector at least covers an upper face of the support and a terminal face of the support.

The invention also proposes a wiper system for wiping at least a glazed surface of the vehicle, notably a motor vehicle, comprising at least one arm and at least one wiper blade exhibiting at least one of the above features and intended to be in contact with the glazed surface, the wiper blade being mechanically connected to the arm by means of an adapter.

The invention additionally provides a vehicle, notably a motor vehicle, comprising at least one glazed surface and a wiper system exhibiting at least one of the above features, the wiper system being configured to clean the glazed surface.

### BRIEF DESCRIPTION OF DRAWINGS

Other features and advantages of the invention will become more clearly apparent, on the one hand, from the following description and, on the other, from a number of exemplary embodiments provided by way of non-limiting indication with reference to the appended schematic drawings, in which:

FIG. 1 schematically depicts a glazed surface of a vehicle equipped with a wiper system for wiping the glazed surface according to the invention;

FIG. 2 is a view of a wiper blade according to the invention, intended to equip a wiper system of FIG. 1, viewed from a first viewing angle;

FIG. 3 is a cross-sectional view of the wiper blade of FIG. 2;

FIG. 4 is a partial view of the wiper blade of FIG. 2, from a second viewing angle;

FIG. 5 is a view of the wiper blade of FIG. 2, from a third viewing angle;

FIG. 6 is a representation, in the form of a graph, of the lifting force exerted on wiper blades at various points, for a first airflow velocity;

FIG. 7 is a representation, in the form of a graph, of the lifting force exerted on wiper blades at various points, for a second airflow velocity.

### DETAILED DESCRIPTION OF THE INVENTION

It should first of all be noted that, although the figures set out the invention in detail for its implementation, they may, of course, be used to better define the invention if necessary. It should also be noted that, in all of the figures, elements that are similar and/or perform the same function are indicated by the same numbering.

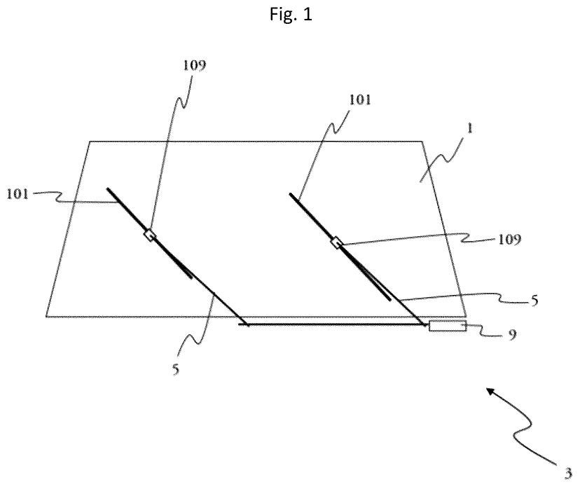

FIG. 1 schematically illustrates a glazed surface 1 of a vehicle, notably a motor vehicle, such as a windshield for example, on which surface a wiper system 3 for wiping the glazed surface 1 is disposed. The glazed surface may also be a rear window or a side window of the vehicle.

The wiping system 3 comprises at least one arm 5, at least one wiper blade 101 attached to the arm 5 and in contact with the glazed surface 1, and a drive device 9 for driving the arm 5. The drive device 9 is configured to set the wiper blade 7 in motion via the arm 5. The movement of the arms 5 is a back and forth movement which may be a linear and/or angular movement.

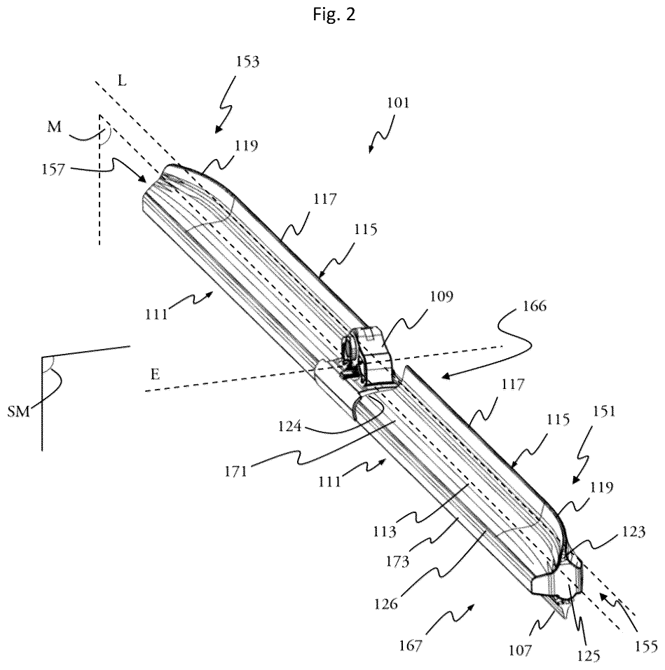

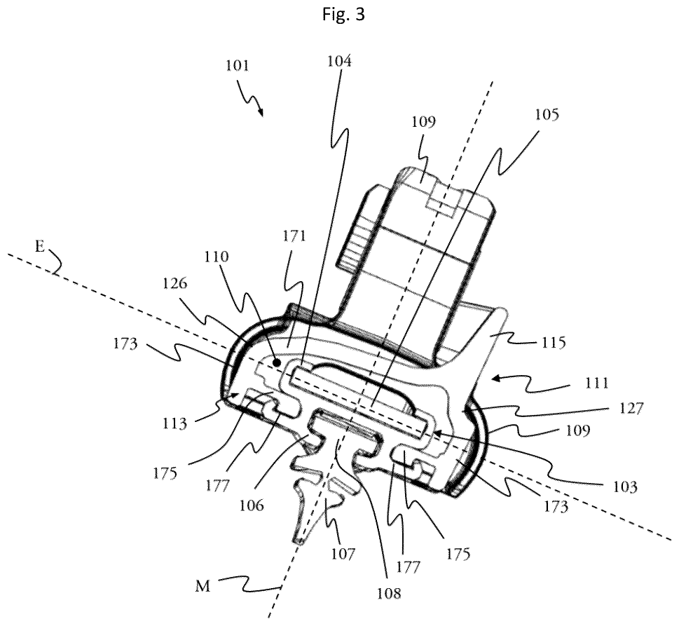

With reference to FIG. 2 and to FIG. 3, the wiper blade 101 extends along a longitudinal axis L. The wiper blade 101 comprises a support 103, a pressure-distribution strip 105 borne by the support 103, a wiping lip 107 borne by the support 103, a connector 109 secured to the support 103 and at least one air deflector 111.

The support 103 extends along an axis parallel to the longitudinal axis L of the wiper blade 101. The support 103 comprises two longitudinal ends 151, 153 which are delimited by terminal edges 155, 157. The terminal edges 151, 153 are connected to one another by longitudinal edges. The terminal edges 151, 153 are substantially perpendicular to the longitudinal axis L of the wiper blade 101, as seen in projection in a plane perpendicular to the longitudinal axis L. The longitudinal edges are substantially parallel to the longitudinal axis L of the wiper blade 101.

As can be seen in FIG. 3, the support 103 comprises a first longitudinal guideway 104 intended to house the pressure-distribution strip 105. The pressure-distribution strip 105 is in the form of a strip that extends over substantially the entire length of the wiper blade 101, namely from one terminal edge 151, 153 of the support 103 to another terminal edge 153, 151 of the support 103. The pressure-distribution strip 105 is a metal component generally made of a flexible steel.

The support 103 also comprises a second longitudinal guideway 106, opposite to the first longitudinal guideway 104, and into which a heel end 108 of the wiping lip 107 is introduced. The heel end 108 of the wiping lip 107 introduced into the second guideway 106 extends from one terminal edge 151, 153 of the support 103 to another terminal edge 153, 151 of the support 103, along an axis parallel to the longitudinal axis L of the wiper blade 101.

The wiping lip 107 may be made up of at least one synthetic material. The synthetic material may for example be an elastomer.

The connector 109 is configured to provide mechanical connection to the arm of the wiping system 3. The connector 109 is arranged on the support 103 in such a way as to divide the support 103 into two longitudinal segments which extend longitudinally one on each side of the connector 109. The two longitudinal segments may be of identical or different lengths, the length of each segment being measured from the connector 109 as far as one of the terminal edges 153, 155 of the support 103 along an axis parallel to the longitudinal axis L. The connector 109 is secured to the support 103 by clipping tabs belonging to the connector 109 into longitudinal grooves belonging to the support 103.

In the embodiment illustrated in FIGS. 2 to 4, the deflector 111 comprises at least a body 113 and a wing 115 projecting from the body 113. The wing 115 and the body 113 extend along a longitudinal axis L of the wiper blade 101.

The deflector 111 has a Shore hardness of between 70 and 80, which allows the deflector 111 to adapt to the shape of the support 103 while the wiper blade 101 is being assembled, without being excessively stiff. The deflector 111 is composed of at least one synthetic material. The synthetic material comprises at least a polyurethane, preferably a thermoplastic polyurethane.

The body 113 extends along an axis parallel to the longitudinal axis L of the wiper blade 101. The body 113 comprises an upper wall 171 and two lateral walls 173 that extend the upper wall 171, longitudinally. The lateral walls 173 of the body are perpendicular to an axis E of airflow over the deflector 111 when the vehicle is in motion. The junction between the upper wall 171 and each lateral wall 173 forms a longitudinal edge 126, 127 of the body 113.

The body 113 comprises a cavity 110 delimited in part by internal faces of the upper wall 171 and of the lateral walls 173. The cavity 110 houses one of the segments of the support 103 when the deflector 111 is mounted on the support 103. Thus, the body 113 partially envelops one of the segments and therefore the support 103. The first guideway 104 is surrounded by the internal faces of the deflector 111.

The body 111 comprises a first terminal part 166 delimited by a terminal edge 124 which is in contact with the connector 109, and by a second terminal part 167 delimited by a terminal edge 125. Each terminal part 166, 167 comprises a portion of the upper wall 171 and a portion of the lateral walls 173 forming the deflector 111.

The second terminal part 167 of the body 113 at least partially covers a longitudinal end 151, 153 of the support 103. The terminal edges 124, 125 of the body 113 are joined together by the longitudinal edges 126, 127 that are parallel to the longitudinal axis L of the wiper blade 101.

Given that part 108 of the wiping lip 107 is in the second guideway 106 of the support 103 and that this part 108 of the wiping lip 107 extends from one terminal edge 151, 153 to another terminal edge 153, 151 of the support 103, the terminal part 167 of the deflector 111 covers a terminal part of the wiping lip 107.

As illustrated in FIG. 2 or 3, the wing 115 comprises a rectilinear portion 117 and a curved portion 119 as viewed along the longitudinal axis L of the wiper blade 101.

The rectilinear portion 117 of the wing 115 is arranged at a longitudinal edge 127 of the body 113. Stated differently, the rectilinear portion 117 of the wing 115 follows the longitudinal edge 127 of the body 113. More specifically, the longitudinal edge 127 followed by the rectilinear portion 117 of the wing 115 is on the downstream side of the airflow when the vehicle is in motion, compared with the other longitudinal edge 126 opposite to the longitudinal edge 127 followed by the rectilinear portion 117 of the wing 115.

Alternatively, the rectilinear portion 117 of the wing 115 is erected at the center of the body 113, considered in its transverse direction perpendicular to the longitudinal axis L. Stated differently, the rectilinear portion 117 of the wing 115 is inscribed in the median plane M detailed above. In such a situation, the curved portion 119 of the wing 115 follows on from the rectilinear portion 117 of the wing 115 and terminates level with one of the longitudinal edges of the body 113.

The rectilinear portion extends from the terminal edge 124 of the first terminal part 166 of the body 113 as far as at least the second terminal part 166 of the body 113. The curved portion 119 extends the rectilinear portion 117 as far as a median longitudinal plane M of the wiper blade 101, a free end 123 of the curved portion being inscribed in the median longitudinal plane. The median longitudinal plane M is a plane in which a surface, belonging to the wiping lip 107, of contact with the glazed surface 1, and a central longitudinal line of the body 113 of the deflector are inscribed.

The free end 123 of the curved portion 119 is arranged at the terminal edge 125 of the second terminal part 167 of the body 113. Thus, when the deflector 111 is mounted on the support 103 as is notably illustrated in FIG. 2, the curved portion 119 of the wing 115 is positioned at one of the longitudinal ends 151, 153 of the support 103. The curved portion 119 of the wing 115 extends over 25% of the length of the deflector 111, measured along the longitudinal axis L of the wiper blade 101.

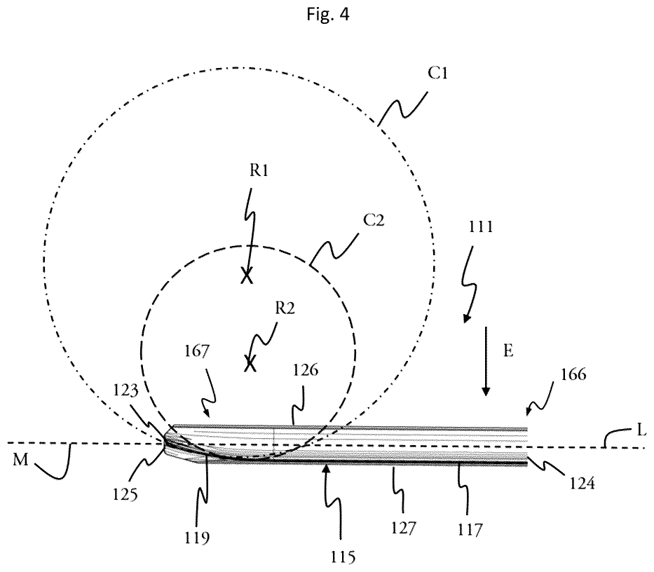

With reference to FIG. 4, the curved portion 119 of the wing 115 is inscribed in a plurality of circles C1, C2 viewed in projection in a plane containing the longitudinal axis L of the wiper blade 101 and the overall airflow axis E. The centers R1, R2 of the circles C1, C2 in which the curved portion 119 is inscribed are non-coincident. In the configuration depicted, the curved portion 119 of the wing 115 is inscribed in circles that have different radii. In an embodiment that has not been depicted, the circles have equal radii.

With reference to FIG. 4, at least one circle of the plurality of circles has a radius of between 5 mm and 180 mm.

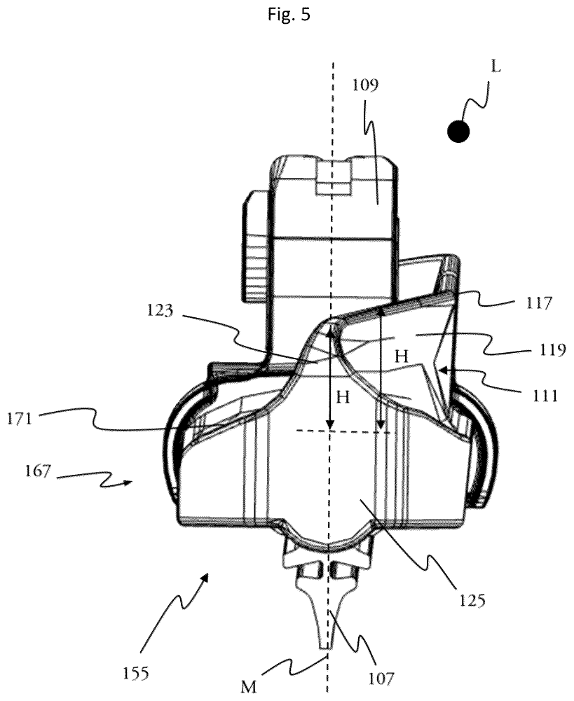

With reference to FIG. 5, the curved portion 119 of the wing 115 has a height H which diminishes from the rectilinear portion 117 of the wing 115 as far as the free end 123 of the curved portion 119. The height H is measured from an external face of the upper wall 171 of the body 113 as far as a top of the curved portion 119 of the wing 115, along an axis perpendicular to the longitudinal axis L of the wiper blade 101 and standing up vertically.

The curved portion 119 of the wing 115 is formed integrally with the rectilinear portion 117 of the wing 115 and the body 113 so as to form a one-piece deflector. The deflector may be obtained using an injection-molding method or a compression-molding method. In one embodiment which has not been depicted, the curved portion of the wing is an end piece distinct from the rectilinear portion and arranged at a longitudinal end of the wiper blade.

With reference to FIG. 3, the lateral walls of the body 113 of the deflector 111 each comprise fixing tabs 175 which extend from the internal face of the lateral walls toward the cavity. The fixing tabs are configured to collaborate with the longitudinal slots of the support 103. Once the wiper blade rubber 107 has been placed on the support 103, each fixing tab is slipped into one of the slots from a longitudinal end 121 of the support 103. The deflector 111 thus slides until the curved portion 119 covers the longitudinal end of the support 103.

As indicated in FIG. 2, the wiper blade 101 comprises another deflector 111 such that the wiper blade 100 is symmetrical about a median plane SM perpendicular to the longitudinal axis L of the wiper blade 101.

Wind-tunnel testing has been performed on the wiper blade 101 according to the invention, a known wiper blade of a first type 200, and a known wiper blade of a second type 300. The wiper blade of the first type and the wiper blade of the second type do not have a deflector with a curved portion at the end of the wiper blade. The wing of the deflectors of those blades is therefore rectilinear from one end of the deflector to the other. Each test consists in measuring the lifting force of the wiper blade at various points spread along the longitudinal direction of the wiper blade, for a given airflow velocity. Two tests were performed at an airflow velocity corresponding to a vehicle driving at 180 km/h.

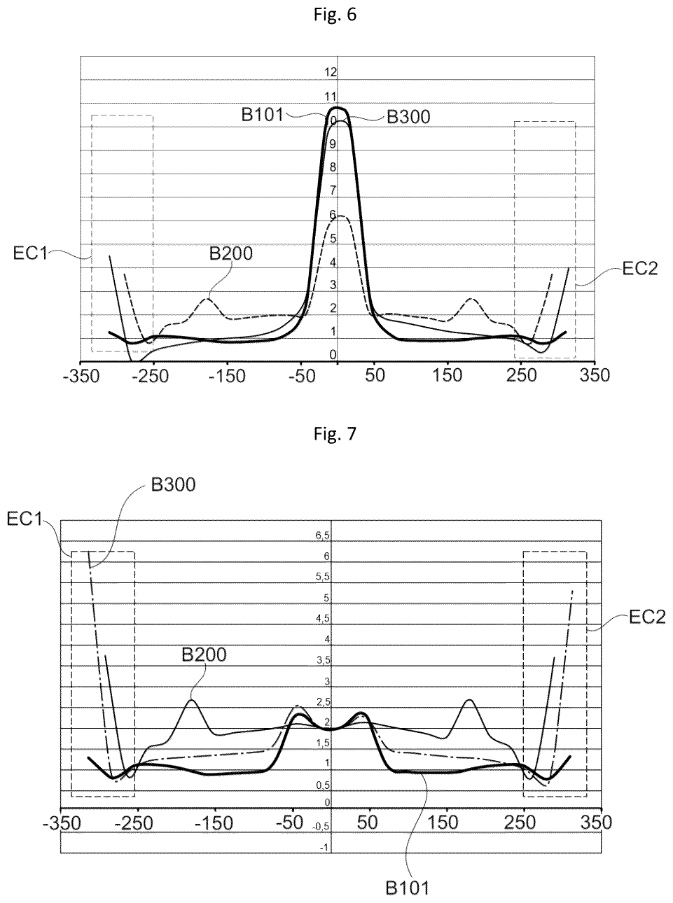

The measurement results from the first test are illustrated on the graph of FIG. 6 and the measurement results from the second test are illustrated on the graph of FIG. 7. The curves B101 in FIGS. 6 and 7 correspond to the lifting-force measurements taken on the wiper blade according to the invention. The curves B200 and B300 in FIGS. 6 and 7 correspond to the lifting-force measurements taken on the wiper blade of the first type 200, and on the wiper blade of the second type 300, respectively.

The boxed regions EC1 and EC2 in FIGS. 6 and 7 correspond to the end conditions at the ends of the wiper blades tested. In other words, for the wiper blade according to the invention, the boxed regions EC1 and EC2 indicate those regions of the wiper blades where the curved part of the wing of the deflectors extends along the support. For the wiper blades 200 and 300, the boxed regions EC1 and EC2 show those regions of the wiper blades where a rectilinear deflector extends.

It may be seen that the lifting force exerted on the ends of the wiper blade according to the invention is very greatly reduced by comparison with the lifting force applied to the ends of the other wiper blades tested.

Of course, the invention is not limited to the examples that have just been described, and numerous modifications may be made to these examples without departing from the scope of the invention. One possibility might be for the wiper blade to comprise a second pressure-distribution strip, which is to say a second spine. In that case, the wiper blade according to the invention may have no support, the connector being secured directly to the two spines.

The invention as has just been described does indeed achieve at least one of its stated objectives, namely that of reducing the lifting force exerted at the ends of the wiper blade. Variants not described here may be implemented without departing from the context of the invention provided that, in accordance with the invention, the wiper blade comprises a deflector of which a wing comprises a rectilinear portion and a curved portion which reduces the lifting force on the wiper blade locally at least at one longitudinal end of the wiper blade.

What is claimed is:

1. A wiper blade for a glazed surface, comprising a support, a wiping lip borne by the support, a connector secured to the support and at lease one air deflector which includes at lest a body and a wing projecting from the body, the wing and the body extending along a longitudinal axis of the wiper blade, wherein the wing includes a rectilinear portion and a curved portion, as viewed along the longitudinal axis of the wiper blade, the curved portion of the wing being located at a longitudinal end of the support.

2. The wiper blade as claimed in claim 1, wherein the curved portion of the wing extends over 5% to 55% of half-length of the deflector measured along the longitudinal axis.

3. The wiper blade as claimed in claim 1, wherein the curved portion extends the rectilinear portion as far as a median longitudinal plane of the wiper blade in which plane is inscribed a surface of contact of the wiping lip with the glazed surface, a free end of the curved portion being inscribed in the median longitudinal plane.

4. The wiper blade as claimed in claim 1, wherein a free end of the curved portion terminates level with a terminal edge of the body which closes one end of the air deflector.

5. The wiper blade as claimed in claim 1, wherein the curved portion is inscribed inside a plurality of circles, the centers of the circles being non-coincident.

6. The wiper blade as claimed in claim 5, wherein at least one circle of the plurality of circles has a radius of between 5 mm and 180 mm.

7. The wiper blade as claimed in claim 1, wherein the rectilinear portion of the wing terminates level with a longitudinal edge of the body at which the deflector is open.

8. The wiper blade as claimed in claim 1, wherein a height of the curved portion diminishes from the rectilinear portion as far as a free end of the curved portion.

9. The wiper blade as claimed in claim 1, wherein a terminal part of the deflector at least partially covers a longitudinal end of the support and a terminal part of the wiping lip.

10. The wiper blade as claimed in claim 1, wherein the curved portion of the wing is formed integrally with the rectilinear portion of the wing and the body so as to form a one-piece deflector.

11. The wiper blade as claimed in claim 1, wherein the curved portion of the wing is an end piece distinct from the rectilinear portion of the wing and arranged at a longitudinal end of the support.
